(19) United States
(12) Patent Application Publication
(10) Pub. No.: US 2024/0221435 A1
(43) Pub. Date: Jul. 4, 2024

(54) SYSTEM AND METHOD FOR VEHICLE REMOTE DIAGNOSTICS

(71) Applicant: FORD GLOBAL TECHNOLOGIES, LLC, Dearborn, MI (US)

(72) Inventors: Marius Plesa, Basildon (GB); Walter Andrew Peregrim, Garden City, MI (US)

(21) Appl. No.: 18/092,604

(22) Filed: Jan. 3, 2023

(51) Int. Cl. G07C 5/00; G07C 5/08

(52) U.S. Cl. CPC G07C 5/008; G07C 5/0808

(57) ABSTRACT

A remote diagnostic system for a vehicle may include a power source configured to provide power to vehicle Electronic Control Modules (ECUs), an in-vehicle network to collect data from the ECUs; a modem configured to receive the collected data from the ECUs and transmit the data to a remote database; a processor configured to analyze the collected data stored in the remote database; determine a health of the vehicle based on the analysis of the collected data; and transmit an action to at least one road side assistance partner based upon the determined health of the vehicle.

### TECHNICAL FIELD

Aspects of the disclosure generally relate to systems and methods for vehicle remote diagnostics

### BACKGROUND

Service vehicles are often dispatched to aid other vehicles having issues that may prevent the vehicle from continuing along its route. Such road side assistance is common, but often times the vehicle dispatched to aid the vehicle, is not equipped to do so, leading to another vehicle having to be dispatched.

### SUMMARY

A remote diagnostic system for a vehicle may include a power source configured to provide power to vehicle Electronic Control Modules (ECUs), an in-vehicle network to collect data from the ECUs; a modem configured to receive the collected data from the ECUs and transmit the data to a remote database; a processor configured to analyze the collected data stored in the remote database; determine a health of the vehicle based on the analysis of the collected data; and transmit an action to at least one road side assistance partner based upon the determined health of the vehicle.

A method for a remote diagnostic system for a vehicle may include receiving a request from a dispatcher for road side assistance, receiving connected vehicle data relating to battery no start status, determining whether additional prognostics data is required for the decision, transmitting, in response to additional prognostic data being required, a request for additional prognostics data, retrieving the prognostics data and analyzing it to formulate a service response decision, and transmitting a recommendation to the dispatcher for the road side assistance action.

A method for a remote diagnostic system for a vehicle may include receiving a request from a dispatcher for road side assistance, receiving connected vehicle data relating to battery no start status, receiving battery data including battery health monitor data and battery prognostic data, and determining, based on the connected vehicle data and the battery data, a road side assistance action, and transmitting a recommendation to the dispatcher for the road side assistance action.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1A illustrates an example diagram including a vehicle configured to access telematics servers and a server having a remote diagnostic application;

FIG. 1B illustrates a simplified example block diagram of components of the methodologies used to collect and analyze data to develop a decision on level of service required depending on vehicle architecture;

FIG. 2 illustrates an example block diagram of components of the remote diagnostic application;

FIG. 3 illustrates an example process for the three methodologies and how each combine in a final decision; and

FIG. 4 illustrates another example block diagram of components of the remote diagnostic application.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Road side assistance is a common practice to provide aid to vehicles that may be having technical difficulties. Often times the vehicle dispatched to aid the distressed vehicle is not aware of what type of issue the distressed vehicle is suffering. In some examples, the vehicle's battery may require a jump start, provide fuel/HV battery charge, inflate tires, etc. However, if such remediation fails, the vehicle may then be required to be towed, requiring a second vehicle capable of towing the distressed vehicle. This second dispatch may increase the cost associated with the assistance, as well as cause delays in the remediating the vehicle.

Typically, an operator of a vehicle may call a road assistance service (RSA) and describe an issue to an operator. The operator may then make a decision on the likely cause of the vehicle issue, such as no start, no crank, etc. The operator may decide whether to send a service vehicle that can provide a jump start, or also a tow truck to move the vehicle to a service center. However, as explained above, a lack of clarity or accuracy in information provided to the operator may results in a second vehicle being dispatched, resulting in higher costs and longer repair times for the operator. Further, such battery related issues increase the costs of battery warranties provided by the manufacturer of the vehicle.

Disclosed herein is a remote diagnostic system that uses connected vehicle (CV), vehicle diagnostic trouble codes (DTCs) and battery health data to accurately differentiate serviceable batteries from faulty batteries, reducing repair or replacement costs. A dashboard or application may allow for RSAs to receive a call and input a vehicle identification number (VIN). Such VIN may allow the RSA to access various vehicle attributes to help in diagnosing the distressed vehicle.

In one example, the CV data may provide a vehicle health report including the DTCs. This vehicle health data may be wireless uploaded and processed by an internal manufacture database. Such DTCs may indicate certain non-battery related issues, such as a bad starter, alternator ignition failure, etc. In another example, the application may receive battery health data that may identify a list of vehicles that have batteries in a low state of health. This may be based on state of charge (SOC) history. The list of vehicles, identified by their VINs, may be included in an automated remote diagnostic request for prognostic information and analyzed to determine if the battery should be replaced or serviced. Further, a second set of battery health data may be included in prognostic data from a battery monitoring sensor (BMS). Analytics from the sensor may be used to determine the battery health.

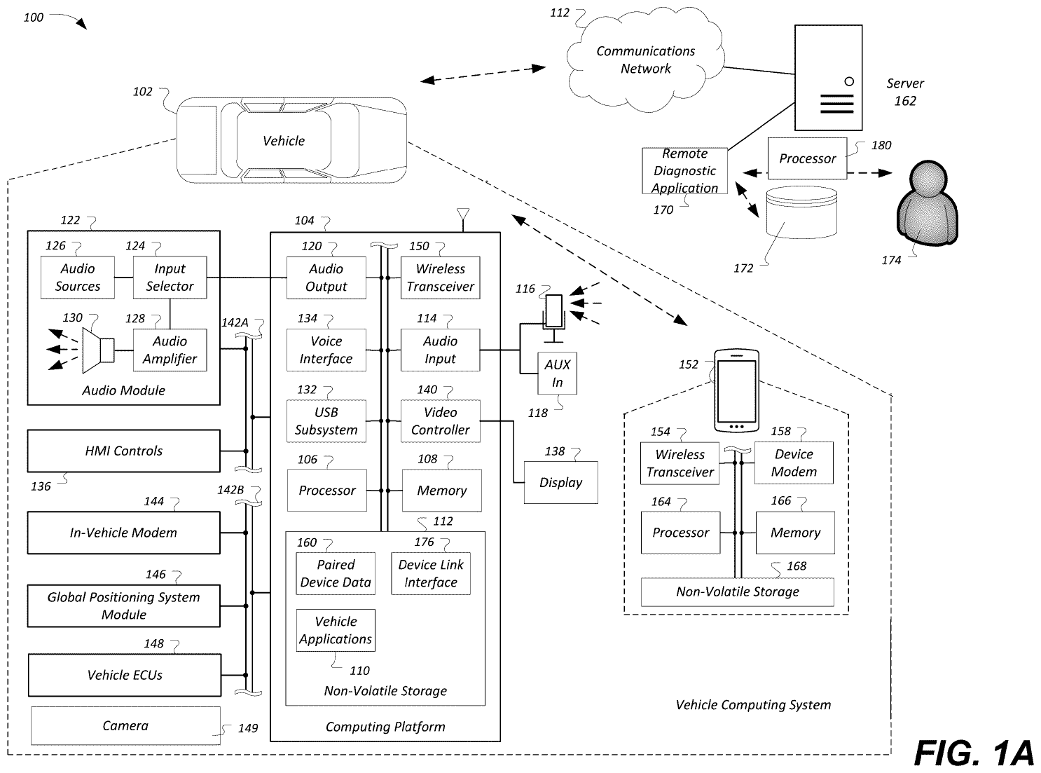

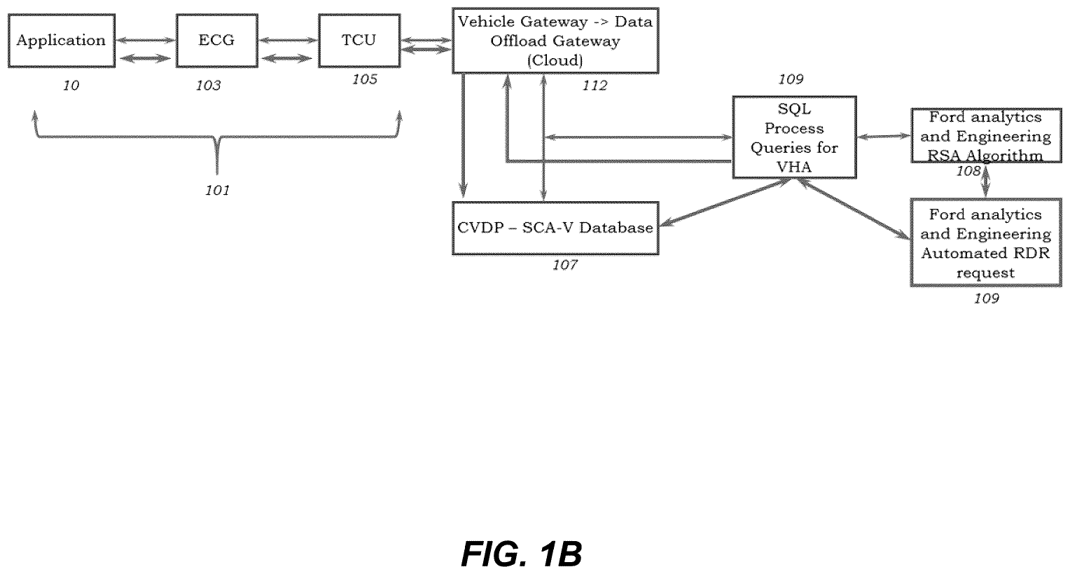

FIG. 1A illustrates an example system 100 including a vehicle 102 configured to access telematics servers and a mobile device 152 having various applications. The vehicle 102 may include various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the vehicle 102 may include the SYNC system manufactured by The Ford Motor Company of Dearborn, MI. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM), frequency modulated (FM) or satellite digital audio radio service (SDARS) signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. An example spoken dialog system is described in U.S. Pat. No. 8,400,332, which is incorporated in its entirety by reference herein. The voice interface 134 may support speech recognition from audio received via the microphone 116 according to grammar associated with available commands, and voice prompt generation for output via the audio module 122. Different decoding speech strategies may be used, such as, phonetic, isolated word, word spotting, phrase recognition, large vocabulary continuous speech (LVCSR), etc. In some examples, different grammar languages and speech recognition engines may be utilized for the different strategies. The voice interface 134 may utilize probabilistic speech techniques using the grammar in comparison to the input speech. In many cases, the voice interface 134 may include a standard user profile tuning for use by the speech recognition functions to allow the speech recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the computing platform 104 and another audio source 126 is selected for playback.

In some examples, a push-to-talk button may be configured to cause voice interface 134 to begin speech recognition. In another example, an “Open Mic” feature may be implemented where the user simply begins to speak without pressing a button. This may be implemented with a voice operated switch (VOX) or with an advanced LVCSR engine that activates for a predetermined set of phrases or words (e.g., a name of the system followed by please, followed by one of a specific set of verbs). The voice interface 134 may also support barge-in, whereby the speech synthesizer begins to provide a prompt before the user has finished the sentence (which is typical of natural speech where a listener begins to speak as soon as they understand the sentence, but before it is completed). Barge-in may also allow a dialog system to intentionally initiate a dialog during moments of silence, or to interrupt and ongoing conversation. This may be used as a tactic for conveying urgency, thus getting the user's attention.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle electronic control units (ECUs) 148 configured to incorporate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

The vehicle 102 may include at least one camera 149 within or on the vehicle 102. The camera 149 may be a video camera, or configured to take still photos, and may be configured to capture areas inside and around the vehicle. In one example, the camera 149 may be an exterior camera used for parking aids, birds eye views, back up cameras, etc.

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally, or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, wearable devices, E-textiles or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132. In some examples the mobile device 152 may be battery powered, while in other cases the mobile device 152 may receive at least a portion of its power from the vehicle 102 via the wired connection.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention. In some vehicles 102, the computing platform 104 wireless transceiver 154 may be configured to provide hotspot functionality to user's mobile devices 152.

The application 170 may be in communication with a database 172 that is configured to maintain data related to the battery health, among other data. The application may maintain daily Vehicle Health data, Vehicle Prognostics Data, Single Actionable Complete-Vehicle (SCA-V) data and RDR data. SCA-V is the database that contains all the Connected Vehicle data that has been uploaded to the database 172. The database 172 may also maintain battery data received from the ECG and cloud, and a list of VINs may be maintained. Such VINs may be associated with other battery-related issues in order to maintain a log of such VINs. The VIN data may be extracted when the service request is received to see if the stored VINs match the requesting VIN. The database 174 may maintain various data so that the VIN, SOC, health, dates of collection, etc., may be easily received to make a determination as to the likelihood of the issue being a battery-related issue.

When a mobile device 152 that supports network connectivity is paired with the computing platform 104, the mobile device 152 may allow the computing platform 104 to use the network connectivity of the device modem 158 to communicate over the communications network 156 with the remote telematics server 162 or other remote computing device. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

| Similar to the computing platform 104, the mobile device 152 may include one or more processors 164 configured to execute instructions of mobile applications loaded to a memory 166 of the mobile device 152 from storage medium 168 of the mobile device 152. In some examples, the mobile applications may be configured to communicate with the computing platform 104 via the wireless transceiver 154 and with the remote telematics server 162 or other network services via the device modem 158. The computing platform 104 may also include a device link interface 172 to facilitate the integration of functionality of the mobile applications into the grammar of commands available via the voice interface 134. The device link interface 172 may also provide the mobile applications with access to vehicle information available to the computing platform 104 via the in-vehicle networks 142. An example of a device link interface 176 may be the SYNC APPLINK component of the SYNC system provided by The Ford Motor Company of Dearborn, MI.

The remote server 162 may include processor 180 and a tool application 170 carried out by the processor 180. The tool application 170 is an off-board or remote application for receiving requests from a technician 174 for a service action. The technician 174 may receive a phone call or other form of communication from a customer requesting road side assistance for the vehicle. The technician may receive a VIN, as well as other information from the customer. The technician 174 may input this information and make a request to the remote diagnostic application 170 requesting recommendation for a type of service to send to the customer. The tool application 170 may receive the request, as well as other data, and use this data to determine the likelihood that the vehicle's situation is caused by a battery-related issue, or some other issue.

The application 170 may create a dashboard configured to access a number of data sets from various sources. This may include cloud based data, sensor based data, as well as manufacture, dealership data, etc. In one example, multiple platforms may be used to determine a likelihood that a vehicle issue is related to the vehicle's battery. Once the application 170 determines this likelihood, the application 170 may then transmit a recommendation to the technician 174 on what type of service to send to the vehicle. For example, for non-battery-related issues, a tow truck may be appropriate. For other issues, a service may be dispatched to issue a jump start. Additionally or alternatively, the dispatcher may instruct for a service provided to provide fuel/HV battery charge, inflate tires, etc.

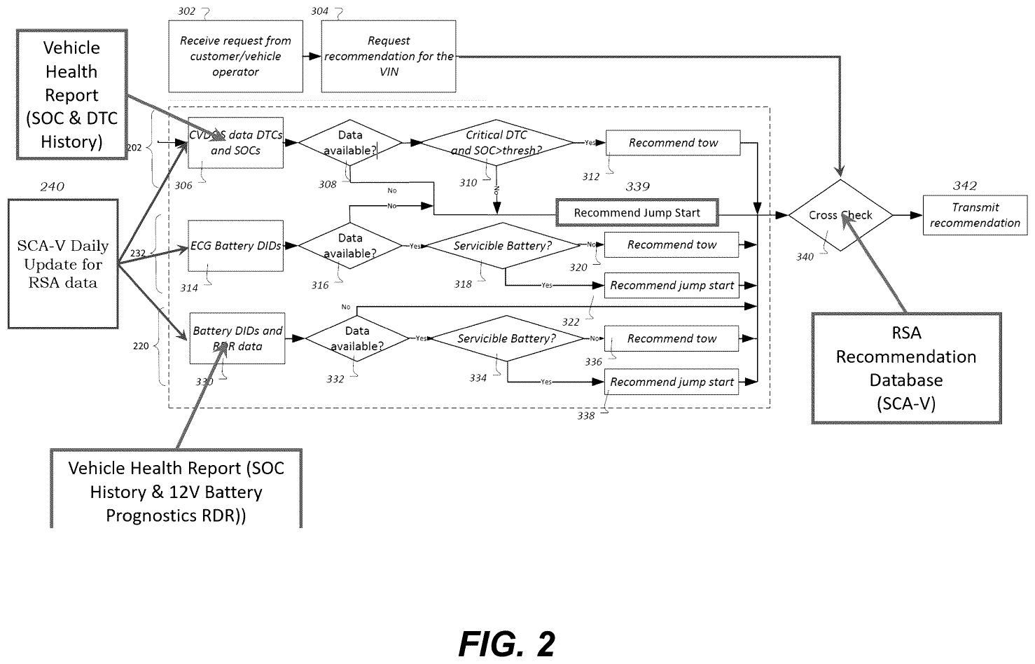

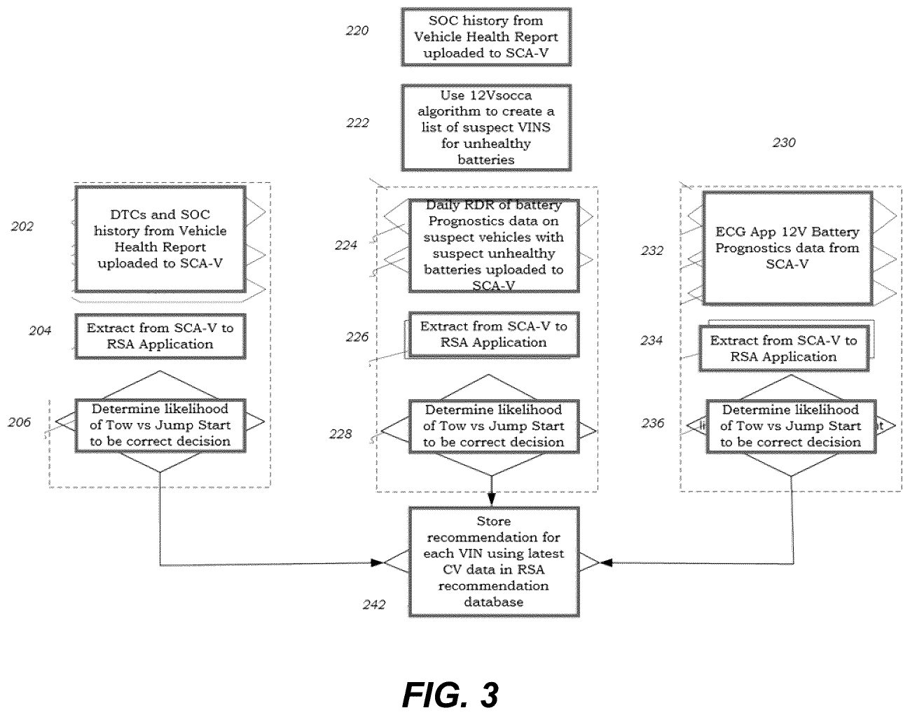

FIG. 1B illustrates a simplified example block diagram of components of the remote diagnostic application 170 including a various components and databases configured to interact in order to facilitate the methods and functions of the application 170. The data may be received from various modules 101 of the ECUs such as the body control modules (BCMs) and power control modules (PCMs), as well as the enhanced central gateway (ECG) 103 and telematic control unit (TCU) 105. This data may be received and updated via the communication network 156, or a vehicle offload gateway via a cloud (e.g. communications network 156). This gateway may communication with a security control assessment validation (SCA-V) database 107. Each of the SCA-V and the data from the cloud may be transmitted to the SQL process 109 for vehicle health alerts. This processing may then be transmitted to the RSA application 111 and the RDR application 113, each of which may return the processed data back to the SQL process 109. This process is described in more detail with respect to FIGS. 2 and 3 below.

FIG. 2 illustrates an example block diagram of components of the remote diagnostic application 170. The remote diagnostic application 170 may be configured to receive data from one or more platforms. One example platform may be a CV platform where connected vehicle (CV) data that provide DTC for a plurality of vehicles. The CV platform of the remote diagnostic application 170 may include a DTC component where the application 170 receives DTCs and SOC history at block 202 from a vehicle health report. Such information may be received from BCMs and PCMs of the ECU of each respective vehicle at each ignition on and off. This history may then be uploaded to the SCA-V.

The SCA-V component may provide safe control of autonomous and connected vehicle (SCAV) reports regarding various vehicles. Such data may be facilitated by large data frameworks such as APACHE HADOOP, in one example.

The application 170 may perform certain processing with respect to the data, including data extraction 204 where the SCAV reports may be extracted and analyzed for relevance related to the current vehicle situation to an RSA application.

The application 170 may also determine, at block 206, a likelihood that a possible remedial action is one that requires a tow, or alternatively, is one that could be remediated via a jump start. Such likelihood could correspond to whether the historical data at block 202 and/or the extracted SCA-V indicated that the battery has a ‘no start’ failure. Such failure may be attributed to an issue with the battery as opposed to another issue such as a faulty ignition, bad alternator, etc. Such a determination may be made at least in part on the acquired data including the CV data, cloud data, SCA-V reports, etc.

The application 170 may also include a battery health platform. This battery health platform may be configured to receive SOC history from the vehicle heath report and upload the report to the SCA-V, similar to block 202, at block 220. At block 222, the application 170 may apply a 12V socca application to create a list of VINs having unhealthy batteries. Such data may be received via the vehicle telematics for pre FNV2 vehicles. This battery health data may be collected from vehicles having been indicated as having potential battery-related issues. Such data may be only collected for VINs by the application 170 that have been identified as having possible sub-par performance.

The battery health platform may also have a daily retail delivery report (RDR) component 224. This RDR component 224 may trigger a daily and automatic RDR for each of the identified vehicles in the battery component 222. The RDR component 224 may obtain prognostic data on the vehicles with suspected unhealthy batteries and may include battery prognostic data identifiers (DIDs). In some examples, the vehicles may be identified, and such information may be received form a connected uplink system such as FORDlive.

The application 170 may perform certain processing with respect to the data for the battery health platform 220, including data extraction 226, similar to block 204, where the SCAV reports may be extracted and analyzed for relevance related to the current vehicle situation to an RSA application at block 228. At block 228, the application 170 may determine a likelihood that an appropriate remedial action requires a tow or is one that could be remediated via a jump start based on the acquired prognostic data.

The application 170 may further include a battery prognostic platform. This battery prognostic platform may be configured to receive data and information regarding the battery health of various vehicles similar to the battery health platform, but the data and information may be received from the enhanced central gateway (ECG) for vehicles having FNV2+. The battery prognostic platform may include an ignition data component 232. The ignition data component 232 may receive data form each vehicle via the ECG at every ignition on and off. This data may include data from the SCA-V. In one example the ECG automatically updates the cloud with the requisite data. A daily upload component 240 may upload data from the cloud daily to the database 172. This may be a daily script to extract the data.

The application 170 may again perform certain processing with respect to the data for the battery prognostic platform 232, including data extraction 236, similar to block 204, where the SCAV reports may be extracted and analyzed for relevance related to the current vehicle situation to an RSA application.

At block 236, the application 170 may determine a likelihood that an appropriate remedial action requires a tow or is one that could be remediated via a jump start based on the acquired prognostic data.

At block 242, each of the determinations made by the respective platforms may be used to provide a vehicle specific recommendation regarding the type of service (e.g., tow vs. jump start). This determination may be based on the likelihood of replacement or recharge, as well as the likelihood of a battery ‘no start’ failure in block 212. Such recommendation may then be transmitted to the RSA technician.

FIG. 3 illustrates an example process 300 for the remote diagnostic application 170. The process 300 may be carried out by the processor 180, or another special or specific processor may be used to carry out the method and instructions of the application 170.

At block 302, an RSA technician may receive a request from a customer or vehicle operator that they need road side assistance. Typically, these requests may come in the form of a phone call, but the request may come in via other mechanisms, such as a text message, app messaging system, on board communication via the telematics system, etc. The customer may indicate to the RSA technician details regarding the vehicle situation so that the RSA technician may better serve the customer but sending the appropriate personnel or vehicle to their aid. Such information may include the VIN.

At block 304, the technician may then request a recommendation from the remote diagnostic application 170. Such a request may be made via an interface of the application 170 and may include entering the VIN. The application 170 may receive the request and the VIN. The process 300 may proceed to block 340.

Within the application 170, at block 306, the processor 180 may receive CV data that provides DTCs for a plurality of vehicles. This is explained above with respect to the CV platform the application 170 receives DTCs and SOC history via the vehicle health report, as well as the SCA-V daily update for RSV data.

At block 308, the processor 180 may determine whether the data is available specific to the VIN. This may include whether data specific to the VIN is extracted. If so, then the process 300 proceeds to block 310. If not the process 300 proceeds to block 339. At block 339, the processor 180 may recommend that the vehicle be jump started.

At block 310, the processor 180 may determine whether the data includes at least one critical DTC, as well as a SOC greater than a predetermined SOC threshold. The predetermined SOC threshold may be, for example, approximately 40%. In general, each VIN that has a critical DTC triggered is stored as part of the application 170. That is, every ignition on, ignition off that has a critical DTC is stored in the database 172. This data may be available anytime via the application 170. In one example, the data may be used to generate a report including the VIN, date, critical DTCs, vehicle parts associated with the DTCs, SOCs, ECU, etc. If the processor 180 determines that the CV data includes at least one critical DTC and a SOC greater than the predetermined SOC threshold, the process 300 proceeds to block 312. If not, the process 300 proceeds to block 339.

At block 312, the processor 180 may recommend that the vehicle be towed in response to receiving at least one DTC and having a SOC exceeding a predefined SOC threshold. The application may make this determination that the battery is not the cause of the vehicle ‘no start’ for each VIN based on the DTC, the SOC, power mode and also other warnings provided with the CV data.

Moving to the battery prognosis platform 232, at block 314, the processor 180 may be configured to receive data and information regarding the battery health of various vehicles from the ECG, as well as the SCA-V daily update for RSV data. Th ECG data may be received from those vehicles having FNV2+. The data may include battery DIDs and RDR data at every ignition on and off.

At block 316, the processor 180 may determine whether the data is available specific to the VIN. This may include whether data specific to the VIN is extracted. If so, then the process 300 proceeds to block 318. If not the process 300 proceeds to block 339.

At block 318, the processor 180 may determine whether the battery is a serviceable battery. This may be based on the ECG prognostic data, for example, the data may indicate whether the battery may be recharged. If so, the process proceeds to block 322. If not, the process 300 proceeds to block 320.

Moving to the battery health platform 220, at block 330, the processor 180 may receive data collected from vehicles having been indicated as having potentially damaged batteries from the SOC and DTC history via the vehicle health report, as well as the SCA-V daily update for RSV data. Such data in some instances may be only collected for VINs that have been identified as having possible damage. This data may include DIDs and RDR data.

At block 332, the processor 180 may determine whether the data is available specific to the VIN. This may include whether data specific to the VIN is extracted. If so, then the process 300 proceeds to block 334. If not the process 300 proceeds to block 340.

At block 334, the processor 180 may determine whether the battery is a serviceable battery. This may be based on the SGA-V data in one example. Specifically, machine learning techniques may be implemented to run daily on SCA-V data searching for vehicles with potential battery health issues based on historical battery SOCs. Vehicles with potential battery health issues may be flagged and result in a list of VINs with possible battery health issues. Daily RDR data may be generated for identified lists of vehicles and the battery health monitor (BHM) DIDs data. This may be stored in the database 172 and be ready for use. If there are not BHM DIDs available, then additional metrics such as battery extracted data, may be used to identify potential battery health problems. If the DIDs are available, then a battery health metric for each VIN may be generated via ECG data and processes. If the battery is serviceable, the process proceeds to block 338. If not, the process 300 proceeds to block 336.

At block 340, the processor 180 may perform a cross-check on the system where the data and determinations made by each of the three platforms is evaluated in comparison with one another, as well as a RSA recommendation database, which may also be stored in database 172, or a separate database. This cross check may be based on the likelihood of replacement or recharge determined in block 318 and block 334, as well as the likelihood of a battery ‘no start’ failure in block 310 based on the DTC and SOC data. Such recommendation may then be transmitted to the RSA technician at block 342.

In addition to providing the technician with a recommendation, the processor 180 may also perform other functions and provide further instructions and data to help facilitate further data collection and provide for efficient repair data. In one example, the processor 180 may provide failing parts information to the dealership or OEM. This may help to facilities global issues with supplier part, recalls, etc. The processor may also provide or analyze the data with respect to engineering warrants and robustness. Moreover, the data may be used for customer messaging, to alert the customer of a possible issue. This may be facilitated via the vehicle telematics service, or in one example, via the FORD PASS. Transport mode diagnostics may also use the data provided by the application n 170.

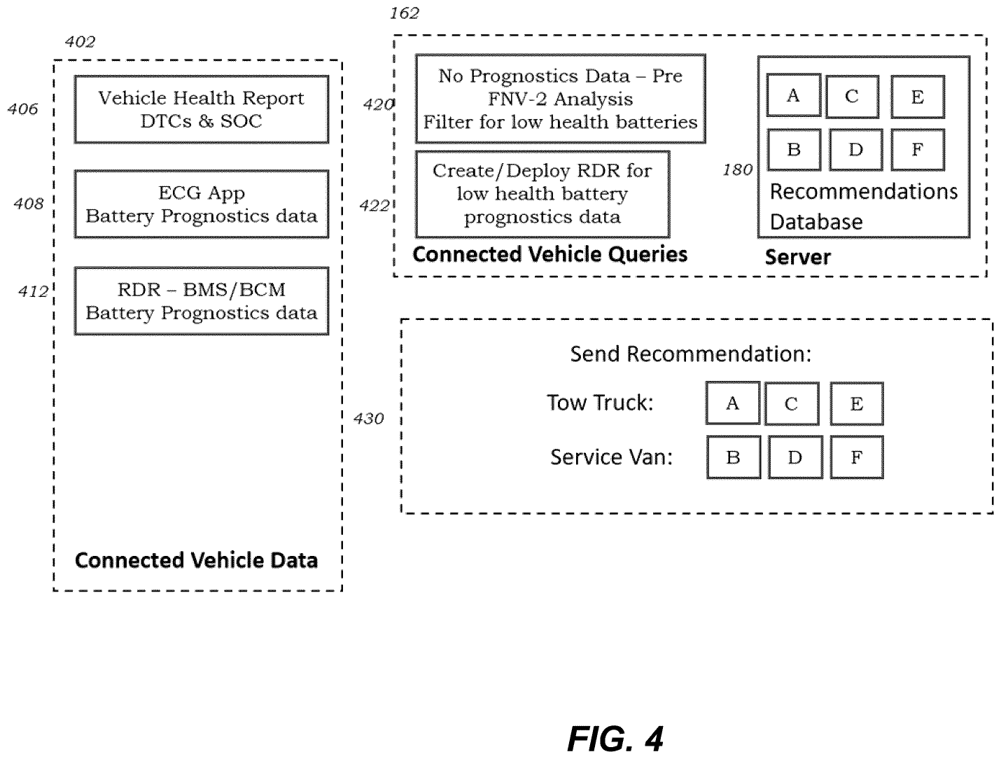

FIG. 4 illustrates another example block diagram of components of the remote diagnostic application 170. As explained, the application may draw data from several locations to predict the likelihood that the vehicle making the service request is experiencing a battery related issue. Connected vehicle data 402, which may include the vehicle health report, including DTCs and SOC at block 406, the ECG Application battery prognostic data at block 408, and the RDR battery prognostic data at block 412.

Thus, the vehicle data 402 includes data and information regarding the battery health of various vehicles via the vehicle telematics for pre FNV2. Data from the cloud database may also be part of the vehicle data 402. Further, for FNV2+ vehicles, ECG supplied data may be included in the vehicle data 402.

The server 162 may maintain a dashboard and the database 172 and include processes and systems that store and process the collected information. The server 162 may process and filter the VINs from all battery data to filter to those VINs having low battery health at block 420. Further, a daily RDR report may be generated and uploaded to the database 172 to request prognostic DIDs relating the battery health at block 422. The database 172 may maintain a plurality of vehicle situations AF. The processor 180 of the server 162 may identify a likely vehicle situation, such as low battery, starter fail, etc., based on the received data. Depending on the vehicle situation, a recommendation type may then be recommended at block 430.

In addition to vehicle data, manufacturer specific data may be supplied. This data may include critical DTC for non-battery related issues and may be provided via connected vehicle data at. The processor 180 may collect the data and aggregate the data in such a way to better serve the RSA technician as well as the customer. In one example, if the collected critical DTCs have a VIN that match the VIN of the vehicle, and the battery SOC is above a threshold, then a tow truck may be recommended (e.g., vehicle situation A in FIG. 4). In another example, if the most recent RDR DIDs process through the application 170 and indicate battery damage or less than 50% life, then a tow truck may be recommended (e.g., vehicle situation B). Further, if the most recent ECG DIDs process through the application 170 and indicate battery damage or less than 50% life, then again, the application 170 will recommend a tow truck (e.g., vehicle situation C). In the event that the above criteria are not met, then the application 170 may recommend a jump start via a service van (e.g., vehicle situation D).

In another example, the method may include transmitting the connected vehicle data and detailed analysis of that data to a dealership/repair facility or providing access for that data to assist in further diagnosis/pre-diagnosis of the vehicle towed to that facility. This may allow for further efficiencies in the repair process.

Accordingly, by using both vehicle and manufacture data, a more robust, accurate and efficient system for dispatching service vehicles may be appreciated.

Various aspects of the current embodiments may be embodied as a system, a method, or a computer program product. Therefore, various aspects of the present disclosure may take the following forms: a complete hardware embodiment, a complete software embodiment (including firmware, resident software, microcode, etc.), or a combination of software and hardware embodiments, which may be all regarded as “module” or “system” generally herein. In addition, any hardware and/or software technology, process, function, component, engine, module, or system described in the present disclosure may be implemented as a circuit or a group of circuits. In addition, various aspects of the present disclosure may take the form of a computer program product embodied in one or more computer-readable media on which computer-readable program code is embodied.

Any combination of one or more computer-readable media may be utilized. The computer-readable mediums may be a computer-readable signal medium or a computer-readable storage medium. The computer-readable storage medium may be, for example, but not limited to, an electronic, magnetic, optical, electromagnetic, infrared, or semiconductor system, device or apparatus, or any suitable combination of the foregoing. More specific examples (non-exhaustive list) of computer-readable storage media may include each of the following: an electrical connection with one or more wires, a portable computer floppy disk, a hard disk, a random-access memory (RAM), a read only memory (ROM), an erasable programmable read-only memory (EPROM or flash memory), an optical fiber, a portable CD-ROM, an optical storage apparatus, a magnetic storage apparatus, or any suitable combination of the foregoing. In the context of this document, a computer-readable storage medium may be any tangible medium that can contain or store a program for use by an instruction execution system, device, or apparatus or in combination with the instruction execution system, device, or apparatus.

The aspects of the present disclosure are described above with reference to flowchart illustrations and/or block diagrams of methods, devices (systems) and computer program products according to the implementations of the present disclosure. It will be understood that each block of the flowchart illustrations and/or block diagrams and combinations of blocks in the flowchart illustrations and/or block diagrams may be implemented by computer program instructions. These computer program instructions may be provided to processors of general-purpose computers, special purpose computers, or other programmable data processing devices to produce machines. When the instructions are executed via the processors of the computers or other programmable data processing devices, the functions/actions specified in the flowchart and/or block diagram block or multiple blocks can be realized. These processors m be, but are not limited to, general purpose processors, special purpose processors, special application processors, or field programmable gate arrays.

The flowcharts and block diagrams in the drawings illustrate the architecture, functionality, and operation of possible implementations of systems, methods, and computer program products according to various embodiments of the present disclosure. In this regard, each block in the flowchart or block diagram may represent a module, section, or part of code, and the code includes one or more executable instructions for implementing prescribed logical functions. It should also be noted that in some alternative implementations, the functionality described in the blocks may occur out of the order described in the drawings. For example, two blocks shown in succession may actually be executed substantially simultaneously, or the blocks may sometimes be executed in the reverse order depending on the functionality involved. It should also be noted that each block in the block diagram and/or flowchart illustration and the combination of the blocks in the block diagram and/or flowchart illustration can be implemented by a dedicated hardware-based system or dedicated hardware and computer instructions that perform the specified functions or actions.

Although the foregoing content is directed to the embodiments of the present disclosure, other and additional embodiments of the present disclosure may be conceived without departing from the basic scope of the present disclosure, and the scope of the present disclosure is determined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A remote diagnostic system for a vehicle, comprising:
a power source configured to provide power to vehicle Electronic Control Modules (ECUs);
an in-vehicle network to collect data from the ECUs;
a modem configured to receive the collected data from the ECUs and transmit the data to a remote database;
a processor configured to
analyze the collected data stored in the remote database;
determine a health of the vehicle based on the analysis of the collected data; and
transmit an action to at least one road side assistance partner based upon the determined health of the vehicle.

2. The system of claim 1, wherein the collected data includes data collected from key modules indicating a non-battery related issue.

3. The system of claim 1, wherein the collected data includes a state of charge for the power source.

4. The system of claim 3, wherein the processor is configured to determine a likelihood that the action is for road side assistance in response to determining an issue with the power source based on at least one DTC and the state of charge.

5. The system of claim 3, wherein the processor is configured to determine that the action for road side assistance partner is related to a non-battery related issue in response to the at least one DTC and the state of charge exceeding a predefined charge threshold.

6. The system of claim 1, wherein the action for road side assistance partner includes a identifying the vehicle to the road side assistance partner.

7. The system of claim 6, wherein the identifying the vehicle includes a VINs associate with battery health data associated with that vehicle.

8. The system of claim 7, wherein the processor is further programed to determine whether the VIN included in the road side assistance request matches a VIN identified in the connected vehicle or battery data.

9. The system of claim 1, wherein the collected data includes data from a battery monitory sensor.

10. The system of claim 1, wherein the battery monitor uploads a battery prognostic data identifier (DIDs) during each Key Off and Key On cycle.

11. The system of claim 1, wherein the connected vehicle data includes SCAV Vehicle Health reports containing at least one of Diagnostic trouble codes (DTCs), key DIDs including battery SOC, tire pressure, fuel levels and coolant levels etc.).

12. A method for a remote diagnostic system for a vehicle, comprising:
receiving a request from a dispatcher for road side assistance;
receiving connected vehicle data relating to battery no start status;
receiving battery data including battery health monitor data and battery prognostic data; and
determining, based on the connected vehicle data and the battery data, a road side assistance action; and
transmitting a recommendation to the dispatcher for the road side assistance action.

13. The method of claim 12, wherein the road side assistance action is one of issuing a tow truck or a service truck for battery jump start.

14. The method of claim 12, wherein the battery health monitor data includes vehicle identification numbers (VINs) and associated battery related issues.

15. The method of claim 14, wherein the request for road side assistance includes a VIN for the vehicle making the request.

16. The method of claim 15, wherein the determining the road side assistance action includes determining whether the VIN included in the road side assistance request matches a VIN identified in the battery health monitor data.

17. The method of claim 12, wherein the battery prognostic data is received via the vehicle ECG.

18. The method of claim 17, wherein the connected vehicle data includes at least one DTC indicating a non-battery related issue and a state of charge for the battery.

19. The method of claim 18, the determining the road side assistance action includes determining a likelihood that the request for road side assistance is related to an issue with the battery based on the at least one DTC and the state of charge exceeding a predefined threshold.

20. A method for a remote diagnostic system for a vehicle, comprising:
receiving a request from a dispatcher for road side assistance;
receiving connected vehicle data relating to battery no start status;
determining whether additional prognostics data is required for the decision;
transmitting, in response to additional prognostic data being required, a request for additional prognostics data;
retrieving the prognostics data and analyzing it to formulate a service response decision; and
transmitting a recommendation to the dispatcher for the road side assistance action.
